(19) United States
(12) Patent Application Publication
(10) Pub. No.: US 2009/0025440 A1
(43) Pub. Date: Jan. 29, 2009

(54) Lock and Key

(76) Inventor: Bart M. Downing, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/829,922

(22) Filed: Jul. 29, 2007

(51) Int. Cl. E05B 49/00

(52) U.S. Cl. 70/283.1

(57) ABSTRACT

Embodiments are directed to a lock and key. In one embodiment, the key includes a battery in a body. The lock includes a first pin that engages the body to move to an unlock position and a second pin that moves to an unlock position when the battery provides power to the lock.

### BACKGROUND

Since many computing devices are small and portable, these devices are often lost or stolen. In order to deter theft, locks are used to secure computing devices to a stationary object. Personal computers, for example, can include a lock for attaching to a security cable.

The mechanical components of a lock can be picked or compromised. Even though a computing device is secured with a mechanical lock, the device can still be stolen.

### BRIEF DESCRIPTION OF THE DRAWINGS

FIG. 1A is a side view of key in accordance with an exemplary embodiment.

FIG. 1B is a top view of the key of FIG. 1A in accordance with an exemplary embodiment.

FIG. 2 is a side view of a lock in accordance with an exemplary embodiment.

FIG. 3 is a block diagram of a lock system securing a computing device to a fixed object in accordance with an exemplary embodiment.

### DETAILED DESCRIPTION

Exemplary embodiments are directed to apparatus, systems, and methods for locking computing devices or computer equipment.

One embodiment uses a solenoid combined with a tumbler lock to deter lock picking of security locks. A key comprises a battery and electrical contacts to provide power to the solenoid located inside the lock. When the key is inserted into the lock, the battery powers the solenoid to retract a solenoid pin. Mechanical cuts on the key move other pins inside of the lock. A plug of the lock rotates and unlocks the lock since the key causes both the mechanical pins and solenoid pin to move to an unlock position.

Without power supplied from the battery in the key, the lock is unable to turn since the solenoid pin prevents the plug from rotating. A mechanical lock picking instrument or key without a battery is not able to actuate all pins to unlock the lock.

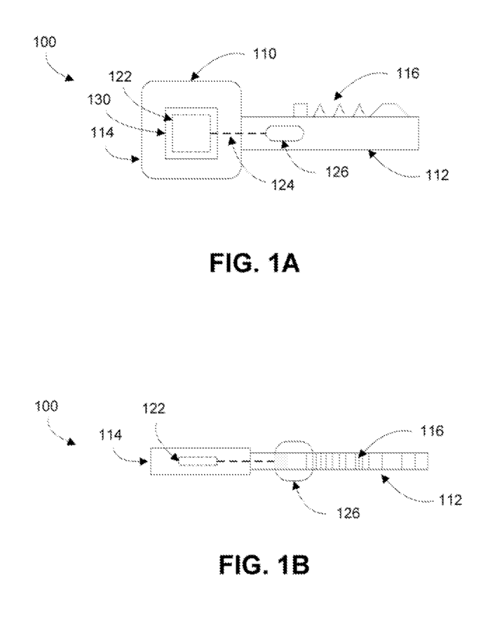

FIGS. 1A and 1B show a key 100 in accordance with an exemplary embodiment. The key 100 comprises a body 110 that includes a blade 112 and a bow 114. The blade 112 has an elongated configuration with one or more cuts, notches, or grooves 116 on one or both sides of the key for engaging and moving pins located in the lock. The bow 114 comprises a battery 122 that electrically couples along an electrical path 124 (example wires) to electrical contacts 126 located in the blade 112.

In one exemplary embodiment, the battery 122 is contained or housed within the body 110. An access or door 130 is provided on the exterior of the bow 114 so the battery 122 can be removed and replaced or repaired.

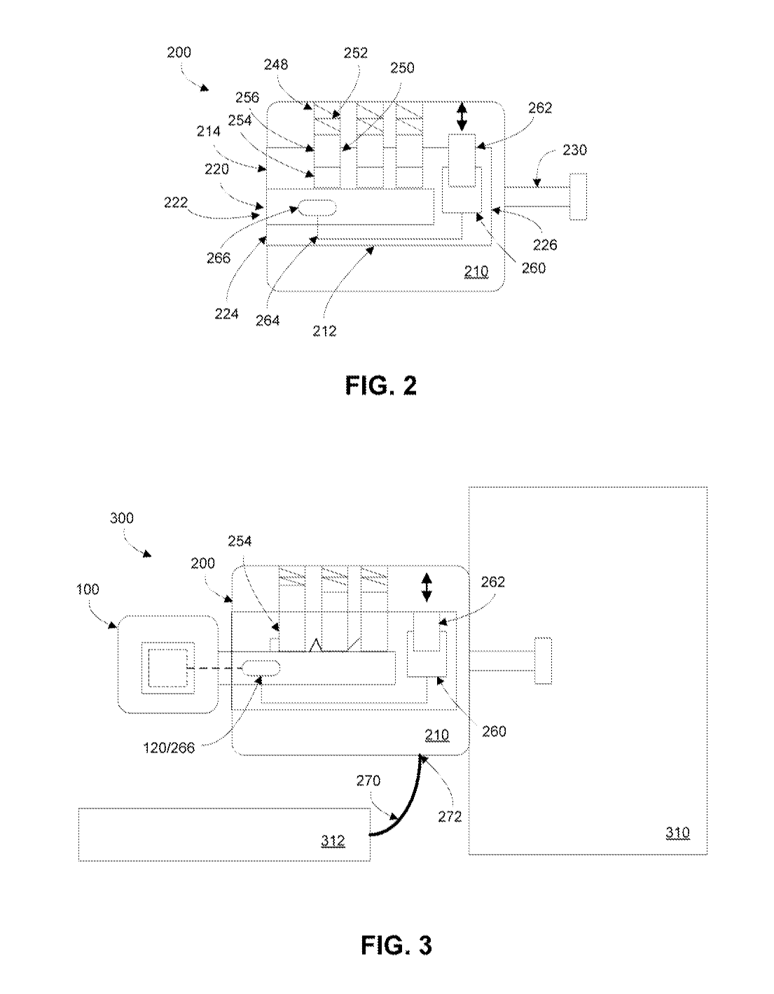

FIG. 2 shows an exemplary lock 200 in accordance with an exemplary embodiment. Exemplary embodiments are used on a variety of different types of locks, such as, but not limited to, cylindrical locks, tubular locks, radial locks, pin tumbler locks, wafer tumbler locks, disc tumbler locks, padlocks, or other locks using a key. For illustration purposes, the lock 200 is shown as a pin tumbler lock.

The lock 200 comprises an outer casing or body 210 having a cylindrical hole 212 that receives a plug 214. The lock 200 closes and opens (locks and unlocks) when the plug 214 rotates within the cylindrical hole 212 in the body 210.

In one exemplary embodiment, the plug 214 has a cylindrical shape with a straight-shaped slot or keyway 220. The keyway 220 extends from an opening 222 at one end 224 of the plug 214 and has a size and shape to match the size and shape of the blade 116 of key 100 (see FIG. 1). A second end 226 of plug 214 comprises a lever or locking mechanism 230 for rotating and attaching the lock to a device (such as a computing device or computer equipment, shown in FIG. 3).

Plural holes 248 extend through the body 210 and into the plug 214. Each hole includes one or more pins 250 and a spring 252. In one exemplary embodiment, each hole includes a key pin 254 and a drive pin 256. The key pins have different lengths and have a rounded end or bottom to slideably engage with grooves 116 of key 100 (shown in FIG. 1).

Springs 252 bias the driver pins 256 against the key pins 254 and prevent the plug 214 from rotating while the pins are in a lock position. Without a key in the keyway 220, the driver pins 256 are positioned between the body 210 and the plug 214 to prevent the plug from rotating in the body.

In one exemplary embodiment, the plug 214 comprises one or more solenoids 260 and solenoid pins 262. The solenoid 260 electrically couples via an electrical path 264 (example, wires) to electrical contacts 266. When power is supplied to the solenoid 260, the solenoid pin 262 moves. While the solenoid receives power from the battery 122 (shown in FIG. 1), the solenoid pin 262 is moved to an unlock position (example, shown in FIG. 3 with one end of the solenoid pin at the shear point). As soon as the solenoid loses power from the battery 122, the solenoid pin retracts or moves to a lock position (example, shown in FIG. 2 with a body of the solenoid pin straddling the shear point and preventing the plug 214 from rotating in the body 210).

In one embodiment, the electrical contacts 126 are oppositely disposed on an exterior surface of the body 110. Further, the electrical contacts 266 are oppositely disposed inside the keyway 220. When the key 100 in inserted into the keyway 220 of the lock 200, electrical contacts 126 align with electrical contacts 266 so battery 122 can provide power to solenoid 260.

In one embodiment, the solenoid 260 produces a magnetic field when electrical current passes through the solenoid. The magnetic field, in turn, causes the metallic solenoid pin 262 to move between locked and unlocked positions.

FIG. 3 shows an exemplary lock system 300 for locking a computing device or computer equipment 310 to a fixed object 312. The lock system 300 comprises the key 100 and the lock 200 discussed in connection with FIGS. 1-2.

Looking to FIGS. 1-3, the location where the plug and cylindrical hole 212 contact is called the shear point. When a properly cut key is inserted into the keyway 220, the key pins 254 move within the cylindrical holes 248 so ends of the key pins align with the shear point so the plug 214 can rotate in the body 210. When an improperly shaped key is in the keyway 220 or no key is in the keyway, then the key pins straddle the shear point and prevent the plug 214 from rotating in the body 210.

When a properly sized key is inserted into the keyway 220, the electrical contacts 126 on the key 100 align with the electrical contacts 266 in the lock 200. Power from battery 122 is provided to solenoid 260 to move solenoid pin 262 so an end of the solenoid pin 262 align with the shear point. When the solenoid pin 262 is at the shear point, the plug 214 can rotate in the body 210. When an improperly shaped key is in the keyway 220 or no key is in the keyway, then power is not provided to the solenoid and the plug 214 is prevented from rotating in the body 210.

In one exemplary embodiment, the locking mechanism 230 engages the computing device 310 to secure the lock 200 to the computing device 310. A cable 270 is connected to the lock and secured to the fixed object 312 to prevent removal or theft of the computing device 310. In one embodiment, one end 272 of the cable 270 permanently attaches to the lock 200 so the cable can be secured to the fixed object 312 (such as an immovable object).

In one exemplary embodiment, the solenoid 260 is actuated when a predetermined amount of power is supplied from the key 100 to the solenoid. For example, the solenoid 260 moves the solenoid pin 262 to the shear point only when the amount of power matches a predetermined amount for the solenoid.

In one exemplary embodiment, a solenoid combined with a tumbler lock deters lock picking of security locks on computer devices and equipment. In order to lock and unlock the computer devices and equipment, the key comprises both a properly configured mechanical cut on the blade portion and a power supply properly located to power the solenoid. When the key is inserted into the lock, the battery powers the solenoid to retract the solenoid pin while the mechanical cuts on the blade move pins in the plug to a shear point. Without supplied power from the battery, a lock picking instrument or key cannot turn the cylinder of the plug since the solenoid pin remains engaged and in a locked position.

Exemplary embodiments can be utilized with and on a variety of locks and computer devices and equipment. For example, lock 200 can be used to lock doors or drawers, such a doors of computer servers or computer racks.

The above discussion is meant to be illustrative of the principles and various exemplary embodiments. Numerous variations and modifications will become apparent to those skilled in the art once the above disclosure is fully appreciated. It is intended that the following claims be interpreted to embrace all such variations and modifications.

What is claimed is:

1) A lock system, comprising:
a key including a body with a battery and a notch; and
a lock including a first pin that moves upon engagement with the notch and a second pin that moves upon receiving power from the battery.

2) The lock system of claim 1, wherein the lock further comprises a solenoid that receives power from the battery to move the second pin.

3) The lock system of claim 1, wherein the key and the lock both further comprise electrical contacts that align when the key is inserted into a keyway of the lock to enable the battery to supply power to move the second pin.

4) The lock system of claim 1 further comprising, a cable with one end permanently attached to the lock for securing the lock to an object.

5) The lock system of claim 1, wherein the lock further comprises a solenoid, an electrical contact, and an electrical pathway that couples the electrical contact to the solenoid.

6) The lock system of claim 1, wherein the key further comprises an electrical contact and an electrical pathway that couples the electrical contact to the battery.

7) The lock system of claim 1, wherein the body of the key includes an opening for removing the battery from the body.

8) A locking system, comprising:
a key including a battery in a body; and
a lock including a first pin that engages the body to move to an unlock position and a second pin that moves to an unlock position when the battery provides power to the lock.

9) The lock system of claim 8 further comprising:
a first electrical contact in the key;
a second electrical contact in the lock, wherein power is supplied from the battery to the lock when the first and second electrical contacts align while the key is inserted into a key way of the lock.

10) The lock system of claim 8, wherein the lock further comprises a solenoid that generates a magnetic field that moves the second pin to the unlock position upon receiving the power from the battery.

11) The lock system of claim 8, wherein one end of the lock attaches to a computing device to deter theft of the computing device.

12) The lock system of claim 8, wherein the key includes an electrical contact that aligns with an electrical contact in the lock to provide an electrical pathway for the power to transmit from the battery to the lock.

13) The lock system of claim 8, wherein an exterior of the key includes two oppositely disposed electrical contacts and an interior of the lock includes two oppositely disposed electrical contacts in a keyway that align with the two electrical contacts in the key when the key is inserted into the lock.

14) The lock system of claim 8, wherein the second pin moves from the unlock position to a lock position when the battery ceases to provide power to the lock.

15) The lock system of claim 8, where in a cylinder in the lock rotates when both the first and second pins are moved to the unlock positions.

16) A method, comprising:
inserting a key into a keyway of a lock;
using a body of the key to mechanically move a first pin inside the lock to an unlocked position; and
using a battery in the key to electrically move a second pin in the lock to an unlocked position.

17) The method of claim 16 further comprising, aligning electrical contacts on the key with electrical contacts in the keyway to provide power from the battery to the lock.

18) The method of claim 16 further comprising, generating a magnetic field with the power from the battery to move the second pin to the unlocked position.

19) The method of claim 16 further comprising, attaching the lock to a computing device to secure the computing device to a fixed object.

20) The method of claim 16 further comprising, actuating a solenoid in the lock to move the second pin to the unlocked position.
